(19) United States
(12) Patent Application Publication
(10) Pub. No.: US 2014/0042138 A1
(43) Pub. Date: Feb. 13, 2014

(54) HOT-WIRE WELDING POWER SUPPLY

(71) Applicant: LINCOLN GLOBAL, INC., City of Industry, CA (US)

(72) Inventor: William T. MATTHEWS, Chesterland, OH (US)

(73) Assignee: LINCOLN GLOBAL, INC., City of Industry, CA (US)

(21) Appl. No.: 13/798,036

(22) Filed: Mar. 12, 2013

Related U.S. Application Data
(60) Provisional application No. 61/681,983, filed on Aug. 10, 2012.

(51) Int. Cl. B23K 37/00

(52) U.S. Cl. CPC B23K 37/00
USPC 219/130.21; 219/130.1

(57) ABSTRACT

A low voltage, low inductance power supply for supplying a current through a filler wire in order to resistance-heat at least an extended portion of the filler wire. The power supply is configured to have an output inductance in a range of 40 to 70 micro henries, a saturation current in a range of 20 to 50 amps, and an open circuit voltage that is less than or equal to 13 volts.

### PRIORITY

The present application claims priority to U.S. Provisional Patent Application No. 61/681,983 filed Aug. 10, 2012, which is incorporated herein by reference in its entirety.

### TECHNICAL FIELD

Certain embodiments relate to controlling heating current in hot filler wire processes used in brazing, cladding, building up, filling, hard-facing overlaying, welding, and joining applications. More particularly, certain embodiments relate to a power supply used to control heating current in filler wire in a system and method for any of brazing, cladding, building up, filling, hard-facing overlaying, joining, and welding applications.

### BACKGROUND

The traditional filler wire method of welding (e.g., a gas-tungsten arc welding (GTAW) filler wire method) can provide increased deposition rates and welding speeds over that of traditional arc welding alone. In such welding operations, the filler wire, which leads a torch, can be resistance-heated by a separate power supply. The wire is fed through a contact tube toward a workpiece and extends beyond the tube. The extension is resistance-heated to aid in the melting of the filler wire. A tungsten electrode may be used to heat and melt the workpiece to form the weld puddle. A power supply provides a large portion of the energy needed to resistance-melt the filler wire. In some cases, the wire feed may slip or falter and the current in the wire may cause an arc to occur between the tip of the wire and the workpiece. The extra heat of such an arc may cause burnthrough and spatter, which adversely affect weld quality.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention relate to a low voltage, low inductance power supply used to control heating current in filler wire in a system and method for any of brazing, cladding, building up, filling, hard-facing overlaying, joining, and welding applications. The low voltage, low inductance power supply supplies a current through a filler wire in order to resistance-heat at least an extended portion of the filler wire. The power supply is configured to have an output inductance in a range of 40 to 70 micro henries, a saturation current in a range of 20 to 50 amps, and an open circuit voltage that is less than or equal to 13 volts. The system also includes a high intensity energy source configured to heat a workpiece to create a molten puddle and a wire feeder configured to feed a filler wire to the molten puddle.

Embodiments of the present invention further include a method of brazing, cladding, building up, filling, overlaying, welding, and joining a workpiece. The method includes heating the workpiece to create a molten puddle and feeding a filler wire to the molten puddle. The method also includes supplying a current through the filler wire in order to resistance-heat at least an extended portion of the filler wire. The resistance heating includes using a low voltage, low inductance power supply as discussed above and further discussed below. Embodiments of the method can include—applying energy from a high intensity energy source to the workpiece to heat the workpiece at least while applying resistance heating to the filler wire using a low voltage, low inductance power supply. The high intensity energy source may include at least one of a laser device, a plasma arc welding (PAW) device, a gas tungsten arc welding (GTAW) device, a gas metal arc welding (GMAW) device, a flux cored arc welding (FCAW) device, and a submerged arc welding (SAW) device.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a functional schematic block diagram of an exemplary embodiment of a combination filler wire feeder and energy source system for any of brazing, cladding, building up, filling, hard-facing overlaying, and joining/welding applications;

FIG. 2 illustrates an exemplary embodiment of a hot wire power supply that can be used in the system of FIG. 1;

FIG. 3 illustrates an exemplary embodiment of a hot wire power supply that can be used in the system of FIG. 1;

FIG. 4 illustrates an exemplary embodiment of a DC to DC converter that can be used in the power supply of FIG. 3; and

FIG. 5 illustrates a functional schematic block diagram of an exemplary embodiment of a combination filler wire feeder and energy source system for any of brazing, cladding, building up, filling, hard-facing overlaying, and joining/welding applications.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

It is known that welding/joining operations typically join multiple workpieces together in a welding operation where a filler metal is combined with at least some of the workpiece metal to form a joint. Because of the desire to increase production throughput in welding operations, there is a constant need for faster welding operations, which do not result in welds which have a substandard quality. This is also true for cladding/surfacing operations, which use similar technology. It is noted that although much of the following discussions will reference “welding” operations and systems, embodiments of the present invention are not just limited to joining operations, but can similarly be used for cladding, brazing, overlaying, etc.—type operations. Furthermore, there is a need to provide systems that can weld quickly under adverse environmental conditions, such as in remote work sites. As described below, exemplary embodiments of the present invention provide significant advantages over existing welding technologies. Such advantages include, but are not limited to, reduced total heat input resulting in low distortion of the workpiece, very high welding travel speeds, very low spatter rates, welding with the absence of shielding, welding plated or coated materials at high speeds with little or no spatter and welding complex materials at high speeds.

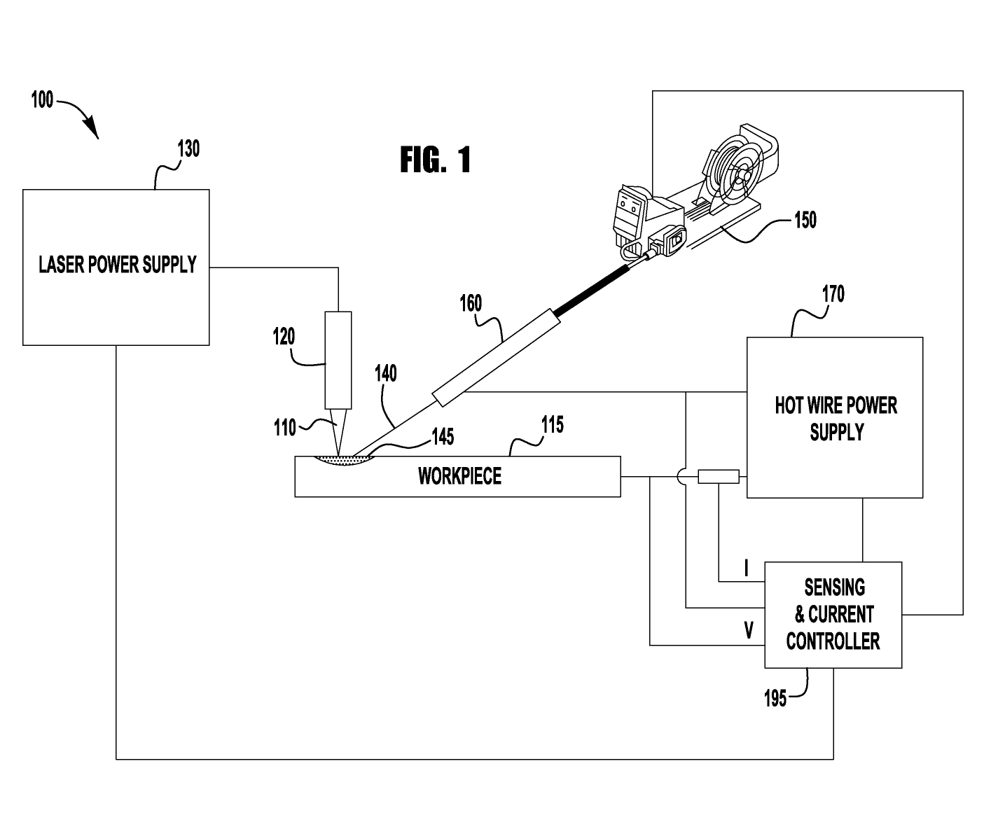

FIG. 1 illustrates a functional schematic block diagram of an exemplary embodiment of a combination filler wire feeder and energy source system 100 for performing any of brazing, cladding, building up, filling, hard-facing overlaying, and joining/welding applications. The system 100 includes a laser subsystem 130/120 capable of focusing a laser beam 110 onto a workpiece 115 to heat the workpiece 115 to create a molten puddle, i.e., weld puddle 145. The laser subsystem includes a laser device 120 and a laser power supply 130 operatively connected to each other. The laser power supply 130 provides power to operate the laser device 120. The laser subsystem is a high intensity energy source. The laser subsystem can be any type of high energy laser source, including but not limited to carbon dioxide, Nd:YAG, Yb-disk, YB-fiber, fiber delivered or direct diode laser systems. Further, even white light or quartz laser type systems can be used if they have sufficient energy. Other embodiments of the system may include at least one of an electron beam, a plasma arc welding subsystem, a gas tungsten arc welding subsystem, a gas metal arc welding subsystem, a flux cored arc welding subsystem, and a submerged arc welding subsystem serving as the high intensity energy source. The following specification will repeatedly refer to the laser system, beam and power supply, however, it should be understood that this reference is exemplary as any high intensity energy source may be used. For example, a high intensity energy source can provide at least 500 W/cm².

It should be noted that the high intensity energy sources, such as the laser devices 120 discussed herein, should be of a type having sufficient power to provide the necessary energy density for the desired welding operation. That is, the laser device 120 should have a power sufficient to create and maintain a stable weld puddle throughout the welding process, and also reach the desired weld penetration. For example, for some applications, lasers should have the ability to “keyhole” the workpiece being welded. This means that the laser should have sufficient power to fully penetrate the workpiece, while maintaining that level of penetration as the laser travels along the workpiece. Exemplary lasers should have power capabilities in the range of 1 to 20 kW, and may have a power capability in the range of 5 to 20 kW. Higher power lasers can be utilized, but can become very costly.

System 100 also includes a hot filler wire feeder subsystem capable of providing at least one resistive filler wire 140 to make contact with the weld puddle 145 in the vicinity of the laser beam 110. The hot filler wire feeder subsystem includes a filler wire feeder 150, a contact tube 160, and hot wire power supply 170. The wire 140 is fed from the filler wire feeder 150 through contact tube 160 toward the workpiece 115 and extends beyond the contact tube 160. The wire 140 is resistance-heated such that the portion extending beyond tube 160 approaches or reaches the melting point before contacting the weld puddle 145 on the workpiece 115. The laser beam 110 serves to melt some of the base metal of the workpiece 115 to form the weld puddle 145 and may also help melt the wire 140 onto the workpiece 115. However, because many filler wires 140 are made of materials which can be reflective, if a reflective type is used, the wire 140 should be heated to a temperature such that its surface reflectivity is reduced, allowing the beam 110 to contribute to the heating/melting of the wire 140. In exemplary embodiments of this configuration, the wire 140 and beam 110 intersect at the point at which the wire 140 enters the puddle 145. The feeder subsystem may be capable of simultaneously providing one or more wires, in accordance with certain other embodiments of the present invention. For example, a first wire may be used for hard-facing and/or providing corrosion resistance to the workpiece, and a second wire may be used to add structure to the workpiece.

During operation, the filler wire 140 is resistance-heated by an electrical current from power supply 170, which is operatively connected between the contact tube 160 and the workpiece 115. In an embodiment of the present invention, power supply 170 is pulsed direct current (DC) power supplies, although alternating current (AC) or other types of power supplies are possible as well. In some exemplary embodiments, the power supply 170 provides a large portion of the heating current through wire 140. In exemplary embodiments, the power supply 170 is a low inductance power supply, i.e., the output circuit in the power supply 170, which is used to output the current to the filler wire 140, has a low inductance. Accordingly, although a large portion of the heating current is supplied by the power supply 170, the power supply 170 can still be responsive to control signals when adjusting the heating current through wire 140 due to its low output inductance. That is, the output current is highly responsive to control signals and can thus change very rapidly, either increasing or decreasing as needed. These adjustments may be needed based on changes in the welding process, e.g., fluctuations in the high energy heat source, disturbances in the filler wire feed due to slips or faltering, changes in the welding environment, etc. In exemplary embodiments, the power supply 170 can have an inductance in the range of 40 to 70 micro henries with a saturation current in the range of 20 to 50 amps. Of course, other systems may have different values and still operate within the spirit and scope of the present invention.

Also in accordance with the present invention, the power supply 170 is a low voltage power supply. In exemplary embodiments, the maximum open circuit voltage of the power supply 170 no more than 13 volts. In some exemplary embodiments, the maximum open circuit voltage is less than 10 volts, while in other exemplary embodiments the maximum open circuit voltage is in the range of 4 to 10 volts. Because its open circuit voltage is less than 10 volts, the power supply 170 will not be able to create or maintain an arc between wire 140 and workpiece 115. In addition, because the power supply 170 has a low inductance, any arc that may form is quickly extinguished, as there is not enough stored energy in the inductance to sustain the arc current for long. Thus, by using a low voltage, low inductance power supply that is consistent with the present invention, the wire 140 can be heated to at or near its melting temperature without the risk of forming an arc (or at least an arc that is sustainable). By the above limitations on the inductance and output voltage of the power supply 170 the power supply 170 is different than arc welding power supplies—which are designed to create and maintain an arc. Having the above attributes the power supply 170 of the present invention is incapable of creating and/or maintaining an arc. As such, the power supply 170 can drive the heating current aggressively—very close to an arc generation level—without the need for extensive control which could be used to avoid the creation of an arc.

The current from the power supply 170 passes to the wire 140 via contact tube 160 (which can be of any known construction) and then into the workpiece 115. This resistance heating current causes the wire 140 to reach a temperature that is at or near the melting temperature of the filler wire 140 being employed as the wire 140 enters the weld puddle 145. In exemplary embodiments, power supply 170 provides more than 50% of the power needed to heat wire 140 to at or near its melting point. In some exemplary embodiments, the power supply 170 may provide 75-95% of the power needed to heat the wire 140 to at or near its melting point. Of course, the melting temperature of the filler wire 140 will vary depending on the size and chemistry of the wire 140. Accordingly, the desired temperature of the filler wire 140 during welding will vary depending on the type of wire being used. The desired operating temperature for the filler wire 140 can be a data input into the welding system so that the desired wire temperature is maintained during welding. In any event, the temperature of the wire 140 should be such that the wire 140 is consumed into the weld puddle 145 during the welding operation. In exemplary embodiments, at least a portion of the filler wire 140 is solid as the wire 140 enters the weld puddle 145. For example, at least 30% of the filler wire 140 is solid as the filler wire 140 enters the weld puddle 145.

In exemplary embodiments of the present invention, the power supply 170 supplies a current which maintains at least a portion of the filler wire 140 at a temperature at or above 75% of its melting temperature. For example, when using a mild steel filler wire the temperature of the wire before it enters the puddle can be approximately 1,600° F., whereas the wire has a melting temperature of about 2,000° F. Of course, it is understood that the respective melting temperatures and desired operational temperatures will varying on at least the alloy, composition, diameter and feed rate of the filler wire. In another exemplary embodiment, the power supply 170 maintains a portion of the filler wire at a temperature at or above 90% of its melting temperature. In further exemplary embodiments, portions of the wire are maintained at a temperature of the wire which is at or above 95% of its melting temperature. In exemplary embodiments, the wire 140 will have a temperature gradient from the point at which the heating current is imparted to the wire 140 and the weld puddle 145, where the temperature at the weld puddle 145 is higher than that at the input point of the heating current. It is desirable to have the hottest temperature of the wire 140 at or near the point at which the wire 140 enters the puddle 145 to facilitate efficient melting of the wire 140. Thus, the temperature percentages stated above are to be measured on the wire 140 at or near the point at which the wires enters the weld puddle 140. By maintaining the filler wire 140 at a temperature close to or at its melting temperature the wire 140 is easily melted into or consumed into the weld puddle 145 created by the heat source/laser 120. That is, the wire 140 is of a temperature which does not result in significantly quenching the weld puddle 145 when the wire 140 makes contact with the puddle 145. Because of the high temperature of the wire 140, the wire 140 melts quickly when it makes contact with the weld puddle 145. It is desirable to have the wire temperature such that the wire 140 does not bottom out in the weld pool—make contact with the non-melted portion of the weld pool. Such contact can adversely affect the quality of the weld.

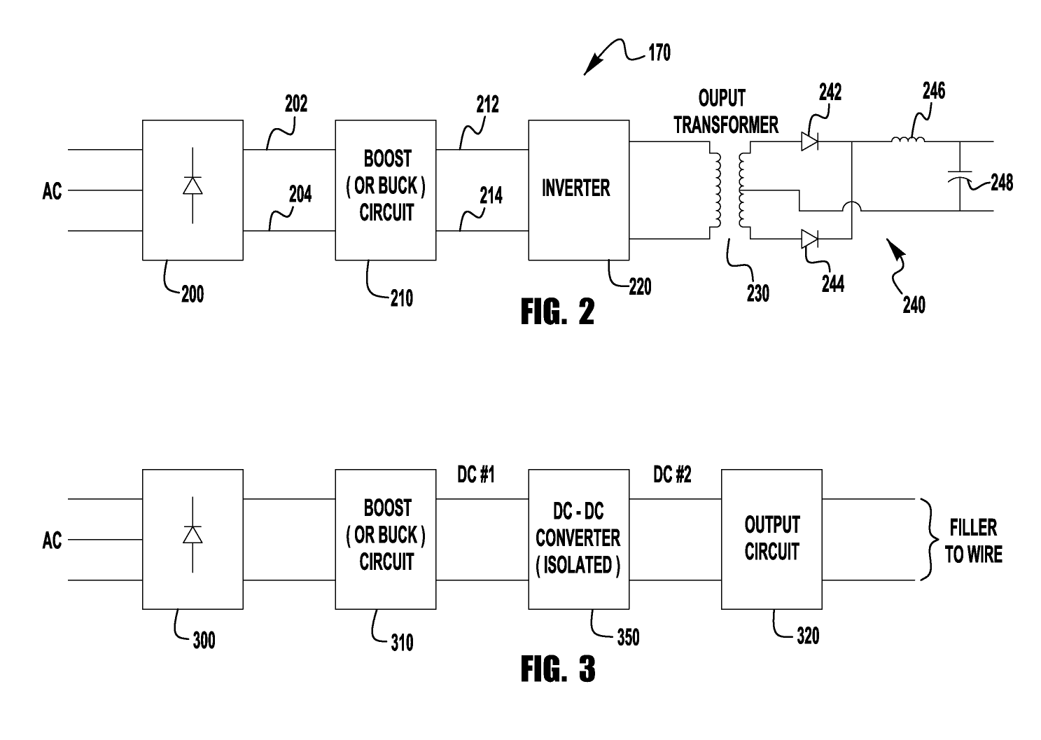

In some exemplary embodiments, the power supply 170 can be a two-stage power supply as shown in FIG. 2. The illustrated two-stage power supply is well-known in the art and, for brevity, only a high-level overview is given. The rectifier 200 receives three phase line AC voltage and rectifies it to a DC voltage, which is output on lines 202 and 204. Typically, the input line AC voltage can range from 100 volts to 575 volts at 50 Hz or 60 Hz depending on the country. Of course, the rectifier 200 can be a single-phase rectifier instead of a three-phase rectifier, and/or the input AC voltage can be provided by a stand-alone generator rather than from a utility line. After being rectified, the DC voltage on bus 202/204 is received by a boost circuit 210, which boosts the input DC voltage to a desired value, e.g., 800 volts. The boost circuit 210 regulates the voltage on bus 212/214 at the desired value even if there are fluctuations in the input AC voltage. Of course, depending on the input AC line voltage and the desired DC voltage on bus 212/214, circuit 210 can be a buck circuit or a buck/boost circuit rather than just a boost circuit. In addition, the circuit 210 can be configured to provide power factor correction if desired. The regulated DC voltage on bus 212/214 is then converted to high frequency AC by inverter 220. The AC from the inverter 220 is converted to a voltage appropriate for heating filler wire 140 by transformer 230. Output circuit 240, which includes diodes 242 and 244, inductor (choke) 246, capacitor 248, can provide a DC output for heating wire 140 when desired. The output transformer 230 is configured and the inverter 220 is controlled such that output voltage is less than or equal to 13 volts. In exemplary embodiments, the output voltage can be less than 10 volts. In some exemplary embodiments, the output voltage is in a range of 4 to 10 volts. The output inductance of the two-stage power supply, which includes inductor 246, is configured such that the inductance is in a range of 40 to 70 micro henries and the two-stage power supply has a saturation current in a range of 20 to 50 amps.

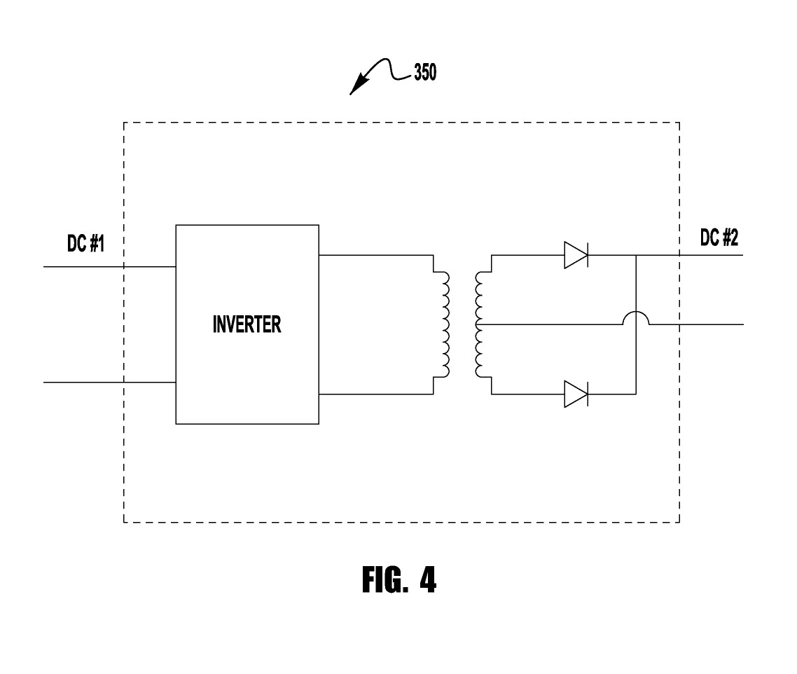

In some other embodiments, the power supply 170 can be a three-stage power supply as shown in FIG. 3. The illustrated three-stage power supply is described in detail in U.S. patent application Ser. No. 10/889,866, filed on Jul. 13, 2004, and incorporated herein by reference in its entirety. For brevity, only a high-level overview is given. Similar to the two-stage power supply discussed above, the input AC voltage is rectified by the rectifier 300 and the boost circuit 310 boosts the rectified voltage to a desired regulated DC voltage. Like the embodiment discussed above, circuit 310 can also be a buck circuit or a buck/boost circuit depending on the input AC voltage and/or the desired regulated DC voltage. The regulated DC voltage is then received by an unregulated DC to DC converter 350. The DC to DC converter 350 can include an inverter, isolated transformer and rectifier to perform the DC to DC conversion as illustrated in FIG. 4. The operation of these components is well-known to those skilled in the art. Of course, other DC to DC configurations may be used in the three-stage power supply. The output DC voltage from the DC to DC converter 350 is sent to output circuit 320. An exemplary embodiment of the output circuit 320 can include the inverter 220, transformer 230 and output circuit 240 discussed above. The output of the three-stage power supply, which can be AC or DC depending on the desired configuration, provides the heating current for the wire 140. Similar to the two-stage design, the three-stage power supply can be configured/controlled (e.g., via DC-DC converter 350 and output circuit 320) such that output voltage is less than or equal to 13 volts. In exemplary embodiments, the output voltage can be less than 10 volts. In some exemplary embodiments, the output voltage is in a range of 4 to 10 volts. The output inductance of the three-stage power supply is configured such that the inductance is in a range of 40 to 70 micro henries and the three-stage power supply has a saturation current in a range of 20 to 50 amps.

Of course, the above embodiments of the power supply 170 are not limiting and the power supply 170 can have other configurations so long as power supply 170 provides the heating current needed to maintain the filler wire 140 at the desired temperature.

In the exemplary embodiments discussed above, the low voltage, low inductance power supply 170 is incapable of sustaining an arc. Accordingly, the system may not need complicated sense and control circuits to control or eliminate arcs. For example, circuits that monitor the output voltage and current from power supply 170 in order to predict when an arc will occur and then control the heating current to prevent (or extinguish) the arc. However, the present invention can include such sense and control circuit to further limit the possibility of forming an arc and/or to limit the duration of any arc that may form during welding operations. Accordingly, as illustrated in FIG. 1, the system 100 may further include a sensing and control unit 195 that is operatively connected to the workpiece 115 and contact tube 160 (i.e., effectively connected to the outputs of power supply 170) and is capable of measuring the potential difference between the output of power supply 170 and the workpiece 115, i.e., voltage V and the current provided by the power supply 170 that goes through the filler wire 140 to workpiece 115, i.e., current I. U.S. patent application Ser. No. 13/212,025, titled “Method And System To Start And Use Combination Filler Wire Feed And High Intensity Energy Source For Welding,” filed Aug. 17, 2011, and incorporated by reference in its entirety, provides start-up and post start-up control methodology that may be incorporated in sensing and control unit 195.

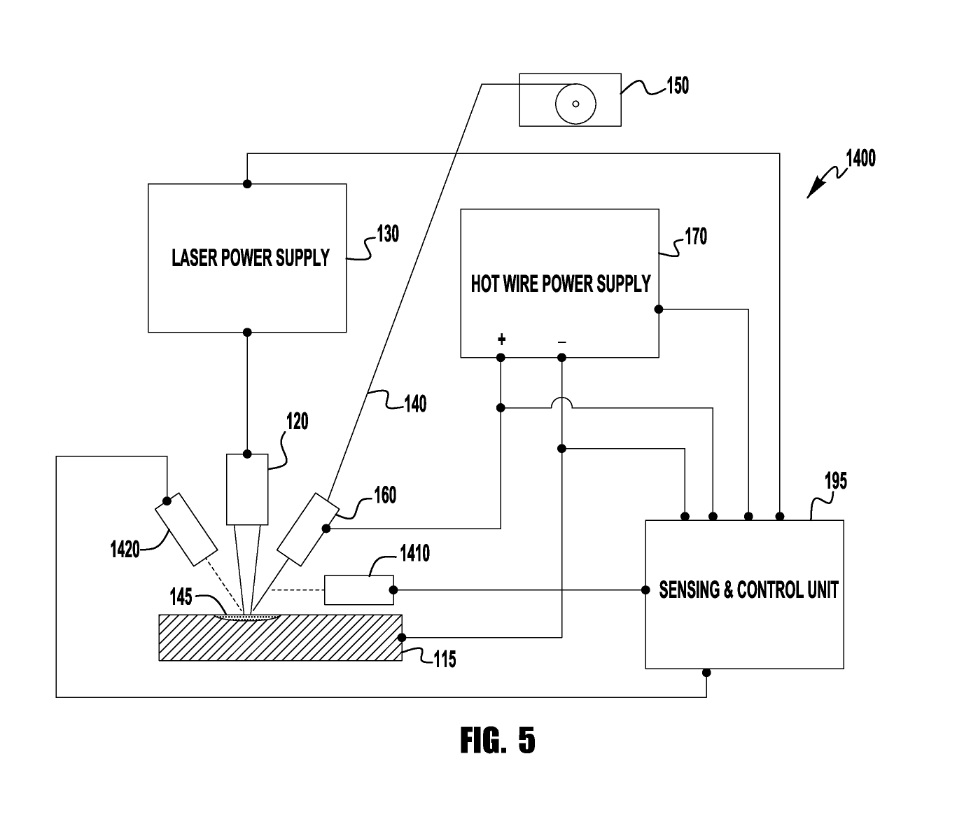

FIG. 5 depicts yet another exemplary embodiment of the present invention. FIG. 5 shows an embodiment similar to that as shown in FIG. 1. FIG. 5 depicts a system 1400 in which thermal sensor 1410 is utilized to monitor the temperature of the wire 140. The thermal sensor 1410 can be of any known type capable of detecting the temperature of the wire 140. The sensor can make contact with the wire 140 or can be coupled to the tip of contact tube 160 so as to detect the temperature of the wire 140 at the tip. In a further exemplary embodiment of the present invention, the sensor 1410 is of a type which uses a laser or infrared beam that is capable of detecting the temperature of a small object—such as the diameter of a filler wire—without contacting the wire 140. Sensor 1410 can be positioned such that the temperature of the wire 140 can be detected at some point between the end of the tip contact tube 160 and the weld puddle 145. The sensor 1410 should also be positioned such that the sensor does not sense the temperature of weld puddle 145.

The sensor 1410 is coupled to the sensing and control unit 195 such that, based on the temperature feedback information, control of power supply 170 and/or the laser power supply 130 can be optimized. For example, the voltage, power, or current output of the power supply 170 can be adjusted based on at least the feedback from the sensor 1410. That is, in an embodiment of the present invention either the user can input a desired temperature setting (for a given weld and/or wire 140) or the sensing and control unit can set a desired temperature based on other user input data (wire feed speed, electrode type, filler wire type, etc.) and then the sensing and control unit 195 would control power supply 170 to maintain the desired temperature at the tip of contact tube 160.

In the above embodiments, it is possible to account for heating of the wire 140 that may occur due to the laser beam 110 impacting on the wire 140 before the wire enters the weld puddle 145. In some embodiments of the present invention, the temperature of the wire 140 can be controlled only by adjusting the output current or power from power supply 170. However, in other embodiments at least some of the heating of the wire 140 can come from the laser beam 110 impinging on at least a part of the wire 140. As such, the current or power from the power supply 170 alone may not be representative of the temperature of the wire 140. Accordingly, utilization of the sensor 1410 can aid in regulating the temperature of the wire 140 through control of the power supply 170 and/or the laser power supply 130.

In a further exemplary embodiment (also shown in FIG. 5) a temperature sensor 1420 is directed to sense the temperature of the weld puddle 145. In this embodiment the temperature of the weld puddle 145 is also coupled to the sensing and control unit 195. Accordingly, in some embodiments of the present invention, control unit 195 may use the feedback from one or more temperature sensors 1410 and 1420 to make the necessary adjustments to power supply 170 to maintain the temperature at the tip of contact tube 160 at the desired temperature. It, of course, should be noted that since the heating has a stick-out which is larger than typical stick-out (because of its distance from the end of the filler wire 140), the current level may need to be adjusted to compensate for any temperature drop due to this distance. In some exemplary embodiments, the desired temperature at the tip of contact tube 160 will be at or near the meting point of the filler wire 140.

In another exemplary embodiment of the present invention, the sensing and control unit 195 can be coupled to a feed force detection unit (not shown) which is coupled to the wire feeding mechanism (not shown—but see 150 in FIG. 1). The feed force detection units are known and detect the feed force being applied to the wire 140 as it is being fed to the workpiece 115. For example, such a detection unit can monitor the torque being applied by a wire feeding motor in the wire feeder 150. If the wire 140 passes through the molten weld puddle 145 without fully melting, it will contact a solid portion of the workpiece and such contact will cause the feed force to increase as the motor is trying to maintain a set feed rate. This increase in force/torque can be detected and relayed to the control unit 195 which utilizes this information to adjust the voltage, current and/or power from at least the power supply 170 to the wire 140 to ensure proper melting of the wire 140 in the puddle 145.

In FIGS. 1 and 5 the laser power supply 130, hot wire power supply 170, and sensing and control unit 195 are shown separately for clarity. However, in embodiments of the invention these components can be made integral into a single welding system. Aspects of the present invention do not require the individually discussed components above to be maintained as separately physical units or stand alone structures.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A system for use in brazing, cladding, building up, filling, overlaying, welding, and joining applications, the system comprising:
a high intensity energy source which heats at least one workpiece to create a molten puddle;
a wire feeder which feeds a filler wire to said molten puddle; and
a power supply which supplies a current through said filler wire in order to resistance-heat at least an extended portion of said filler wire, said power supply having an output inductance in a range of 40 to 70 micro henries, a saturation current in a range of 20 to 50 amps, and an open circuit voltage that is less than or equal to 13 volts.

2. The system of claim 1, wherein said power supply resistance-heats at least said extended portion of said filler wire to at or near a melting temperature of said filler wire.

3. The system of claim 1, wherein said power supply resistance-heats at least said extended portion of said filler wire to at or above 75% of a melting temperature of said filler wire.

4. The system of claim 1, wherein said open circuit voltage is less than 10 volts.

5. The system of claim 1, wherein said open circuit voltage is in a range of 4 to 10 volts.

6. The system of claim 1, further comprising:
a control unit which senses at least one of a temperature of said extended portion of said filler wire and a temperature said molten puddle,
wherein said control unit adjusts said output of at least one of said high intensity energy source, said wire feeder, and said power supply based on said sensing and a desired temperature.

7. The system of claim 6, wherein said control unit sets said desired temperature based on a user input.

8. The system of claim 7, wherein said user input is at least one of wire feed speed and filler wire type.

9. A low voltage, low inductance power supply for use in hot wire applications, the power supply comprising:
an output circuit which supplies a current,
wherein said power supply has an output inductance in a range of 40 to 70 micro henries, a saturation current in a range of 20 to 50 amps, and an open circuit voltage that is less than or equal to 13 volts.

10. The power supply of claim 9, wherein said open circuit voltage is less than 10 volts.

11. The power supply of claim 9, wherein said open circuit voltage is in a range of 4 to 10 volts.

12. A method of brazing, cladding, building up, filling, overlaying, welding, and joining at least one workpiece, the method comprising:
heating said at least one workpiece to create a molten puddle;
feeding a filler wire to said molten puddle; and
supplying a current through said filler wire in order to resistance-heat at least an extended portion of said filler wire using a low voltage, low inductance power supply, said power supply having an output inductance in a range of 40 to 70 micro henries, a saturation current in a range of 20 to 50 amps, and an open circuit voltage that is less than or equal to 13 volts.

13. The method of claim 12, wherein said power supply resistance-heats at least said extended portion of said filler wire to at or near a melting temperature of said filler wire.

14. The method of claim 12, wherein said power supply resistance-heats at least said extended portion of said filler wire to at or above 75% of a melting temperature of said filler wire.

15. The method of claim 12, wherein said open circuit voltage is less than 10 volts.

16. The method of claim 12, wherein said open circuit voltage is in a range of 4 to 10 volts.

17. The method of claim 1, further comprising,
sensing at least one of a temperature of said extended portion of said filler wire and a temperature said molten puddle, and
controlling at least one of said heating of said at least one workpiece, said feeding of said filler wire, and said supplying of said current based on said sensing and a desired temperature.

18. The method of claim 17, further comprising,
setting said desired temperature based on a user input.

19. The method of claim 18, wherein said user input is at least one of wire feed speed and filler wire type.
